(19) United States
(12) Patent Application Publication
(10) Pub. No.: US 2009/0177652 A1
(43) Pub. Date: Jul. 9, 2009

(54) MOBILE SEARCH SERVICE

(75) Inventor: Alistair Markham, Cambridge (GB)

Correspondence Address: BARNES & THORNBURG LLP, P.O. BOX 2786, CHICAGO, IL, 60690-2786, US

(73) Assignee: Taptu Ltd., Cambridge (GB)

(21) Appl. No.: 12/349,568

(22) Filed: Jan. 7, 2009

Related U.S. Application Data
(60) Provisional application No. 61/019,609, filed on Jan. 8, 2008.

(51) Int. Cl. G06F 17/30

(52) U.S. Cl. 707/5; 707/E17.108

(57) ABSTRACT

At least some embodiments of this invention provide for a way to mix mobile content found as a result of searching and/or browsing on the Internet. Aspects of the invention provides software, systems (meaning software and hardware to run the software) or an exchange of signals with users to provide a mobile content service. Other related aspects provide methods for providing or using such a search service. According to one aspect there is provided a query server to provide a search service for searching computer accessible content, the query server being arranged to receive a search query from a user on a mobile device, output said search query to multiple sources of indexable information, input an individual list of results from each of said multiple sources together with a scoring for each result wherein each result has a position in its associated individual list determined by its scoring, combine said lists of results to form a single combined list wherein results in said single combined list are ranked using a combination of their scoring and position in their respective individual list and send said combined list of search results to a user's mobile device.

### RELATED APPLICATIONS

This application claims the benefit of earlier filed provisional application Ser. No. 61/019,609 filed Jan. 8, 2008 entitled “Method of Mixing Search Results from Multiple Categories.

This application also relates to five earlier U.S. patent applications, namely Ser. No. 11/189,312 filed 26 Jul. 2005, published as US 2007/00278329, entitled “processing and sending search results over a wireless network to a mobile device”; Ser. No. 11/232,591, filed Sep. 22, 2005, published as US 2007/0067267 entitled “Systems and methods for managing the display of sponsored links together with search results in a search engine system” claiming priority from UK patent application no. GB0519256.2 of Sep. 21, 2005, published as GB2430507; Ser. No. 11/248,073, filed 11 Oct. 2005, published as US 2007/0067304, entitled “Search using changes in prevalence of content items on the web”; Ser. No. 11/289,078, filed 29 Nov. 2005, published as US 2007/0067305 entitled “Display of search results on mobile device browser with background process”; and U.S. Ser. No. 11/369,025, filed 06 Mar. 2006, published as US2007/0208704 entitled “Packaged mobile search results”. This application also relates to US provisional applications Ser. No. 60/946,729 filed Jun. 28, 2007 entitled “Method of Enhancing Availability of Mobile Search Results”, Ser. No. 60/946,730, filed Jun. 28, 2007 entitled “Social distance search ranking”, Ser. No. 60/946,728, filed Jun. 28, 2007 entitled “Ranking Search Results Using a Measure of Buzz”, and Ser. No. 60/946,726, filed Jun. 28, 2007 entitled “Audio Thumbnails”.

The contents of these applications are hereby incorporated by reference in their entirety.

### FIELD OF THE INVENTION

This invention relates to query servers for providing a mobile search service, to corresponding methods of using a mobile search service, and corresponding apparatus and software.

### DESCRIPTION OF THE RELATED ART

Search engines are known for retrieving a list of addresses of documents on the Web relevant to a search keyword or keywords. A search engine is typically a remotely accessible software program which indexes Internet addresses (universal resource locators (“URLs”), usenet, file transfer protocols (“FTPs”), image locations, etc). The list of addresses is typically a list of “hyperlinks” or Internet addresses of information from an index in response to a query. A user query may include a keyword, a list of keywords or a structured query expression, such as Boolean query.

Known Internet search engines take a query from a user and return a list of search results. A typical search engine “crawls” the Web by performing a search of the connected computers that store the information and makes a copy of the information in a “web mirror”. This has an index of the keywords in the documents. As any one keyword in the index may be present in hundreds of documents, the index will have for each keyword a list of pointers to these documents, and some way of ranking them by relevance.

For all search engines, the order that results are displayed in will depend on many factors, but are typically derived from at least a measure of how well the search terms matched the candidate documents and some measure of the significance or popularity of those document independent of the search terms. For example, it is known to rank hypertext pages based on intrinsic and extrinsic ranks of the pages based on content and connectivity analysis. Connectivity here means hypertext links to the given page from other pages, called “backlinks” or “inbound links”. These can be weighted by quantity and quality, such as the popularity of the pages having these links. PageRank(™) is a static ranking of web pages used as the core of the search engine known by the trademark Google (http://www.google.com).

This ranking arrangement works fine for search services where all candidate documents are handled by the same algorithm and displayed in the same manner, e.g. all discoverable web-pages on the Internet but does not lend itself to the situation where there are multiple types of documents, each scored in a type-specific manner and displayed with a type-specific presentation. Other known search engines currently solve this problem by offering the user the choice, up front, of performing a Web search versus an Image search or a Product search. Once this choice has been made, the problem is reduced to the original arrangement whereby results of only one type are being displayed. Other services solve the problem by dividing the results page into multiple regions and displaying a single result-type per region.

Search engines for searching the world wide web are well developed for accessing the web from a desktop personal computer (i.e. a computer having a keyboard, mouse and display say bigger than 1000×1000 pixels). On a desktop search service, such as Google and Ask.com, such solutions for addressing searches which provide multiple types of documents work reasonably well. Mobile devices that are capable of accessing content on the world wide web are becoming increasingly numerous. Some of the problems of known mobile search services are addressed in US 2007/00278329, US 2007/0067267, US 2007/0067304, US 2007/0067305 and US2007/0208704 to the present applicants and the contents of these applications are herein incorporated by reference.

The present applicant has realized that further improvements are possible, particularly to address searches which provide multiple types of documents.

### SUMMARY OF THE INVENTION

According to one aspect there is provided a query server to provide a search service for searching computer accessible content, the query server being arranged to

receive a search query from a user on a mobile device,

output said search query to multiple sources of indexable information,

input an individual list of results from each of said multiple sources together with a scoring for each result wherein each result has a position in its associated individual list determined by its scoring,

combine said lists of results to form a single combined list wherein results in said single combined list are ranked using a combination of their scoring and position in their respective individual list and

send said combined list of search results to a user's mobile device.

According to another aspect there is provided a method of providing a search service for searching computer accessible content, the method comprising

receiving a search query from a user on a mobile device,

outputting said search query to multiple sources of indexable information,

inputting an individual list of results from each of said multiple sources together with a scoring for each result wherein each result has a position in its associated individual list determined by its scoring,

combining said lists of results to form a single combined list wherein results in said single combined list are ranked using a combination of their scoring and position in their respective individual list and

sending said combined list of search results to a user's mobile device.

In other words, the results are served in a single combined (mixed list) containing examples from multiple types which is much more beneficial on a mobile handset where the display is perhaps only 200×200 pixels. On such handsets, there is little room to divide up the results into separate regions as proposed for desktop services (although this is the solution adopted currently by e.g. m.yahoo.com) without generating a very long page requiring time-consuming scrolling to view. The invention addresses the difficulty of arranging the scoring of mixed search results, when the factors (e.g. scores and distributions of scores) are type-specific.

The invention provides an arrangement whereby results of multiple types are mixed in relevancy order. By using both ranking and scoring from the original individual lists, the combined list will have some result diversity across the different types. As explained in more detail below, the arrangement may provide convenient and tunable control over the importance placed upon result diversity.

Various aspects of the invention are set out in the independent claims. Any additional features can be added, and any of the additional features can be combined together and combined with any of the above aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows schematically an overview of some of the complete system principal entities involved in an embodiment of the invention,

FIG. 2 shows a schematic view of some features of the system shown in FIG. 1;

FIG. 3a shows a schematic view of an alternative mixing engine for use in the system shown in FIG. 1;

FIG. 3b shows the steps of a method implemented by the mixing engine of FIG. 3a;

FIG. 4a shows a schematic view of a second alternative mixing engine, and

FIG. 4b shows the steps of a method implemented by the mixing engine of FIG. 4a.

### DETAILED DESCRIPTION

### DEFINITIONS

Online means accessible by computer over a network and so can encompass accessible via the internet or public telecommunications networks, or via private networks such as corporate intranets.

Content items encompasses web pages, or extracts of web pages, or programs or files such as images, video files, audio files, text files, or parts of or combinations of any of these and so on.

User can encompass human users or services such as meta search services.

Items which are “accessible online” are defined to encompass at least items in pages on websites of the world wide web, items in the deep web (e.g. databases of items accessible by queries through a web page), items available internal company intranets, or any online database including online vendors and marketplaces.

Hyperlinks are intended to encompass hypertext, buttons, softkeys or menus or navigation bars or any displayed indication or audible prompt which can be selected by a user to present different content.

The term “comprising” is used as an open-ended term, not to exclude further items as well as those listed.

### DETAILED DESCRIPTION OF THE DRAWINGS

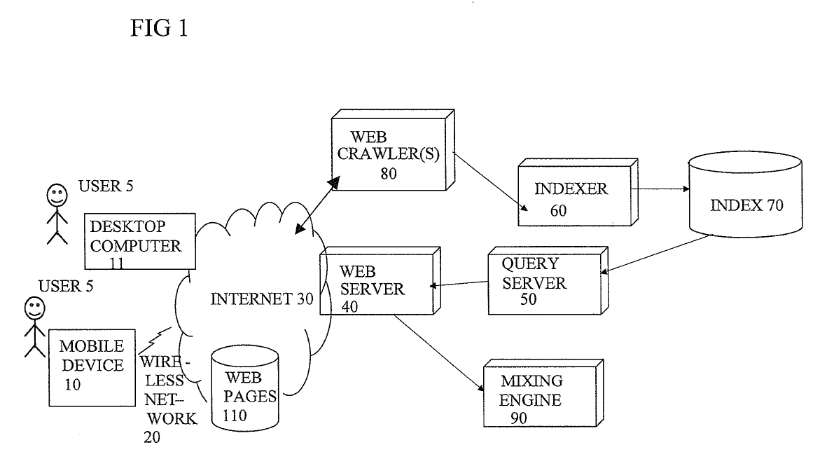

The overall topology of the embodiments of the invention is illustrated in FIG. 1 which shows a mobile search service deployed using the normal components of a search engine. The search engine service is deployed using the query server 50 to prompt for and respond to queries from users. The indexer 60 populates the index 70 containing word occurrence lists (commonly referred to as inverted word lists) together with other meta-data relevant to scoring. The back-end crawler 80 scans for and downloads candidate content (“documents”) from the web (or other source of indexable information). This system can be formed of many servers and databases distributed across a network, or in principle they can be consolidated at a single location or machine. The term search engine can refer to the front end, which is the query server in this case, and some, all or none of the back end parts used by the query server, whose functions can be replaced with calls to external services.

A plurality of users 5 connected to the Internet via desktop computers 11 or mobile devices 10 can make searches via the query server. The users making searches (‘mobile users’) on mobile devices are connected to a wireless network 20 managed by a network operator, which is in turn connected to the Internet via a WAP gateway, IP router or other similar device (not shown explicitly). The search results sent to the users by the query server can be tailored to preferences of the user or to characteristics of their device.

The documents fetched and supplied to the indexer 60 can be of numerous different types, e.g. images, music files, restaurant reviews, wikipedia™ pages. For each type of document, various score data is also obtained using type-specific methods, e.g. restaurant reviews documents might have user supplied ratings, web pages have traffic and link-related metrics, music links often have play counts etc.

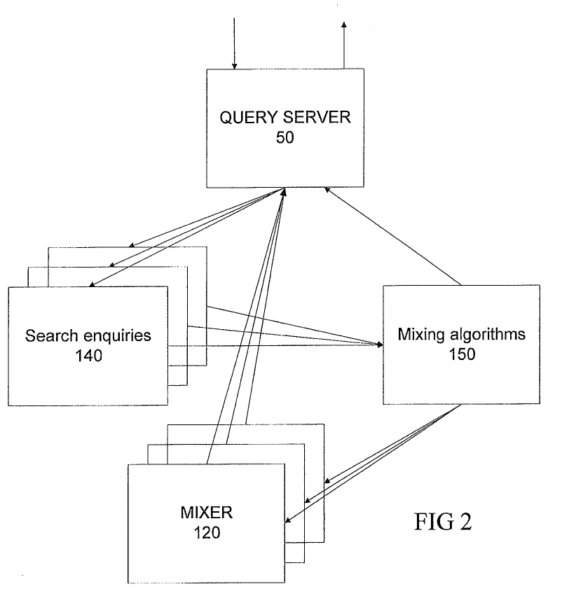

FIG. 2 is a schematic drawing of some key features of the system. After a search query is received by the query server 50, it is separated into individual search enquiries 140 which will be sent to each search engine, e.g. news engine, songs engine etc. The query server also associates each individual query 140 with a mixing algorithm 150 and this information is passed to the mixers 120. As described in more detail below, there may be a single mixer applying a mixing algorithm to all the results or there may be more than one mixer each applying the same or different mixing algorithm so that the results from one genre are not overrepresented in the overall list.

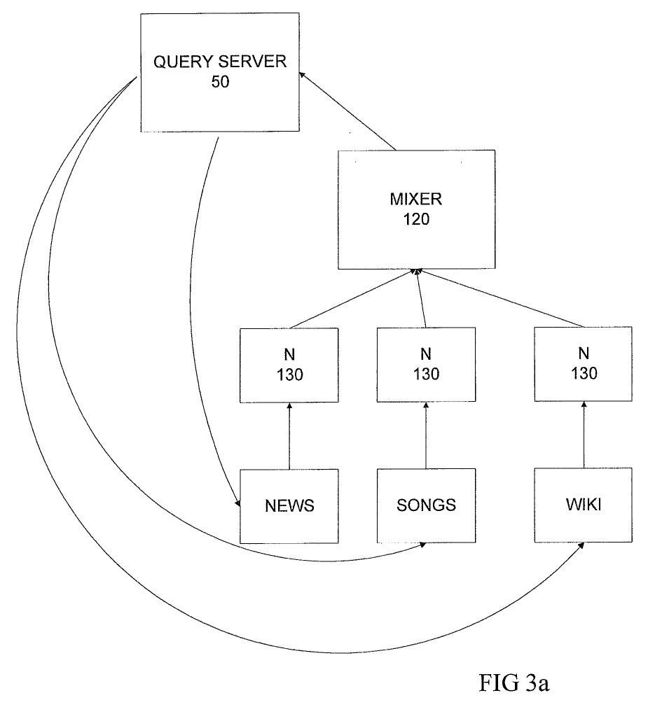

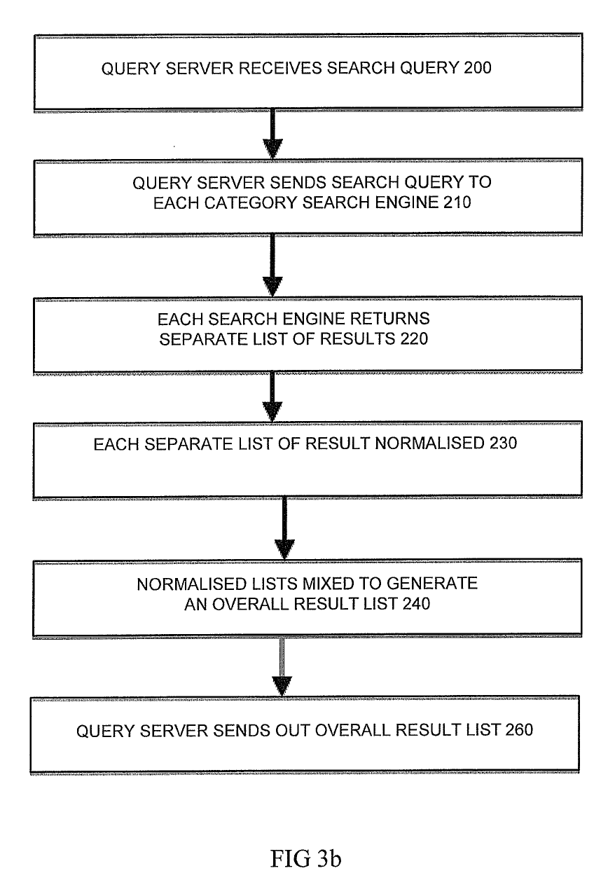

As shown in FIG. 1, the normal components of a search engine are connected to a mixing engine 90 to generate the mixed list. The components of a simple mixing engine are shown in FIG. 3a. When a search is performed, the query server performs a search within each type (news, songs and wikipedia as shown in FIG. 3a) and generates a (potentially long) list of candidate documents per type that match or are close to the query terms. The table below illustrates two different buckets of search results, namely news and songs:

| | | | SONGS | | |
|---|---|---|---|---|---|
| NEWS | | | Scoring | | |
| Scoring (date based) | | | (based on no. plays) | | |
| 1 | Headline a | 182000 | 1 | Song a | 3 million |
| 2 | Headline b | 52000 | 2 | Song b | 20000 |
| 3 | Headline c | 33000 | 3 | Song c | 55 |
| 4 | Headline d | 15000 | 4 | Song d | 2 |

As shown above, each candidate document is assigned a type-specific score by combining its type-specific metrics using type-specific algorithms. These metrics include both static scoring data such as data obtained at crawl time and dynamic scoring data produced depending on the query terms and the words contained in the documents. For example, for news items, the scoring may be primarily based on date but may also be influenced by the popularity of the item.

The results from the multiple lists are each passed to a normalisation unit N 130. The normalisation step is type-specific and involves scaling the type-specific score distribution into a generic score distribution such that document scores from different types can be reasonably compared against each other when sorting lists of documents of different types. The normalisation can be as simple as a linear scaling factor or a more complex algorithm that also modifies the distribution of scores within a standard range to better compare the relative rank of the Nth document of one type with Nth document of another type.

The normalised (or generic) scores for each type of document are passed to a mixer 120 to mix the results from the multiple lists. A combination of the generic scores and the position (rank) of each document within its type-specific list is used to rank the documents. The first step of this mixing (i.e. normalisation) is to enable inter-type score comparisons and the second step is to provide means to promote result diversity (i.e. promoting the likelihood of getting results of different types).

The combination of a generic score, g, with a type-specific result rank, r, can be any function f(g,r) provided that relative result ordering is maintained within each type, i.e. the condition is satisfied:

f(g_{N}, N)>f(g_{M}, M) for any N<M

where g_{N} is the generic score of the Nth highest-scoring document of type X and g_{M} is the generic score of the Mth highest-scoring document of the same type X.

For example, the following function obviously rewards the generic score g and penalises high (i.e. bad) rank positions r:

$$f ( g , r ) = \frac{g}{r}$$

This is a very simple example and a real function might well be much more complex in shape. Suitable functions generally will reward a high value of g and penalise a high value of r.

A slightly more complex example involves making the combination function tunable. This may be convenient when tunability is a highly desirable feature in the development of a search engine using this arrangement of components. Thus, the function may be:

$$f ( g , r ) = ag + \frac{( 1 - a )}{r}$$

where a is a tuning factor with a=1 meaning no diversity, pure result rankings only and a=0 means pure diversity, one result from each category taken in sequence. Values of a between 0 and 1 are likely to represent a more sensible approach than either extreme.

FIG. 3b shows the steps implemented by the mixing engine of FIG. 3a. The query server receives the search query S200 and sends it to each category search engine S210. Each search engine returns a list of results S220 which are normalised S230 and then mixed S240 before outputting to a user.

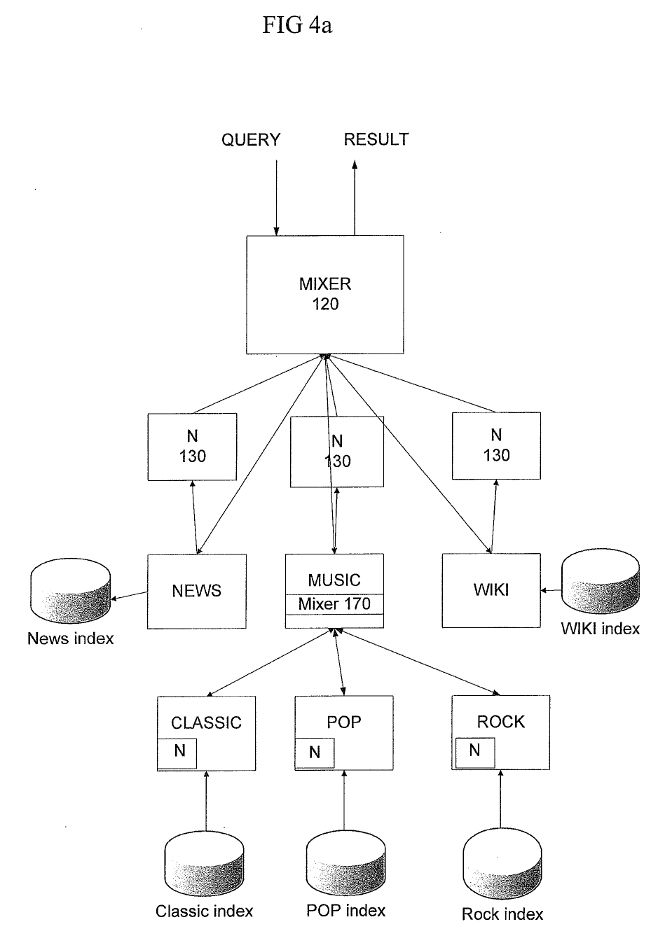

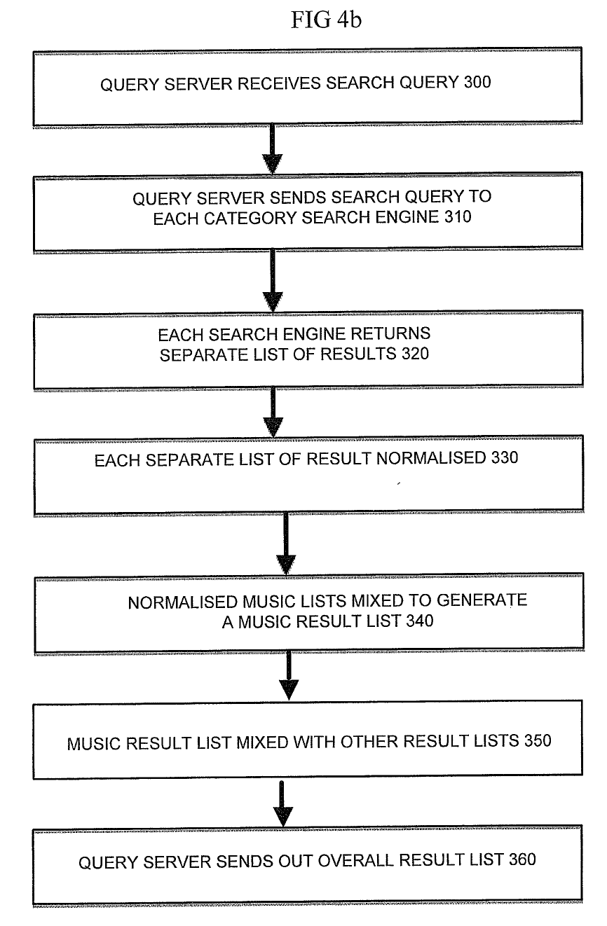

FIG. 4a shows a variation on the mixing engine of FIG. 3a which incorporates trees of streams. In other words, various genre within one category are mixed before mixing with different categories. As shown in FIG. 4a, the music category is subdivided into three genres, pop, classic and rock each having its own independent index. In this embodiment, the query passes via the main mixer 120 through the music mixer 140 so that a search is conducted over each separate music index. For each music genre, a list of candidate documents that match or are close to the query terms is generated together with a scoring of the relevancy of each document. The scoring for each genre is normalised and the normalised results are passed to the music mixer 170 for mixing. The results for each type of music are then mixed, as described above e.g. using the function described above and the tuning factor al, to generate an overall list of music results. Such a list may be considered to represent an interim combined list, and the various music lists may be considered to be selected lists.

Whilst the music results are being generated, the search query is also sent to a news index and a Wiki index (i.e. a collection of web pages e.g. Wikipedia), each generating a list of type specific results. No interim combined list is formed for the news and Wiki results and thus if the music lists are considered to be selected lists, the news and Wiki lists may be considered to be non-selected lists. The music, news and Wiki results are independently normalised using the appropriate technique by normalisation units 130. The normalised results of each type are then mixed in mixer 120, as described above e.g. using the function described above and the tuning factor a₂, to yield a single list of results. In other words, the query server is arranged to form at least one interim list, namely for music and then to combine the results from the non-selected lists, e.g. for news and Wiki, with the results in the interim combined list. It will be appreciated that the tuning factor a₁ used for the initial music mixing may differ from the tuning factor a₂ used for the final mixing step. If the separate music categories were each mixed individually with news and wiki results, music may be overrepresented in the overall result list. However, by using two mixing steps, any lumpiness in the overall list may be reduced, e.g. by defining the mixing algorithms so that if two songs are adjacently listed in the results, the next result is from a different category.

It will be appreciated that the tuning parameters (a₁, a₂) could be varied in real-time. This variation may be dependent for example on the search term that has been entered, or on the quality of the results from the various type-specific search engines. In this way, the balance of diversity versus type-specific score may be adapted depending on how applicable that diversity is.

FIG. 4b shows the steps implemented by the mixing engine of FIG. 4a. The query server receives the search query S300 and sends it to each category search engine S310. Each search engine returns a list of results S320 which are normalised S330. The normalised results from the music category and then mixed S340 to generate a music results list. This music list is then mixed with the results from the other categories S350 to generate an overall list before outputting to a user S360. As it will be appreciated, the mixing of the results from a particular category (i.e. a pre-mixing step) may apply to multiple categories before an overall mixing step is completed.

In all embodiments, each item in the results list is a single search result. The representation of a search result may be the content items main title, a summary description and other optional meta data such as links to the source site, links to related items, links to re-perform the search which produced the item and so on. Each result row in the list may also includes an image, a title, a description and a link to the online content which the result is representing.

It is primarily the intention that the tuning parameters of the relevant functions are useful for system administrators only. However, it is conceivable that a service might wish to use the above method to expose some factors as configurable user preferences.

The query server may provide for user login. The user is identified by registering a username and password and then subsequently by logging in with the same username and password. The registration process is a one-time process per user. In a preferred embodiment, the login process is also a one-time process per user by caching their credentials (or a unique key representing their identity) in a cookie. However, where cookies are not supported then the user is required to provide username and password for each use. The user could be required to login at the first page of the mobile search service or a later stage. Once a user has logged in, the user may be able to manually adjust the tuning factor to be used for mixing. Thus, the query server may be arranged to prompt a user to adjust the tuning factor. Alternatively, the system may automatically adjust the tuning factor to suit a particular user and such adjustment may be done in real-time.

As described above, wikipedia results are included in the overall results list. Wikipedia or other similar databases may also be used to help refine the search. For example, before sending the search query out to each category search engine, the query server may check on Wikipedia for the various meanings or interpretations for a particular search term. These results may be used to bias the search results, e.g. by biasing for particular categories which include the most likely meaning of the search term used. The tuning factor may thus be adjusted in real-time to achieve this biasing.

In all of the above embodiments, a mobile device may be any kind of mobile computing device, including laptop and hand held computers, portable music players, portable multimedia players, mobile phones. Users can use mobile devices such as phone-like handsets communicating over a wireless network, or any kind of wirelessly-connected mobile devices including PDAs, notepads, point-of-sale terminals, laptops etc. Each device typically comprises one or more CPUs, memory, I/O devices such as keypad, keyboard, microphone, touchscreen, a display and a wireless network radio interface.

These devices can typically run web browsers or microbrowser applications e.g. Openwave™, Access™, Opera™ Mozilla™ browsers, which can access web pages across the Internet. These may be normal HTML web pages, or they may be pages formatted specifically for mobile devices using various subsets and variants of HTML, including cHTML, WML, DHTML, XHTML, XHTML Basic and XHTML Mobile Profile. The browsers allow the users to click on hyperlinks within web pages which contain URLs (uniform resource locators) which direct the browser to retrieve a new web page.

The Web server can be a PC type computer or other conventional type capable of running any HTTP (Hyper-Text-Transfer-Protocol) compatible server software as is widely available. The Web server has a connection to the Internet 30. These systems can be implemented on a wide variety of hardware and software platforms.

The summary page or package of screenviews which may be created as described in US 2007/00278329, US 2007/0067305 or US2007/0208704 can be implemented as a set of pages in XHTML Mobile Profile for example. As indicated by the W3C website, XHTML Mobile Profile is one in a series of XHTML specifications. The XHTML Mobile Profile document type includes the minimal set of modules required to be an XHTML Host Language document type, and in addition it includes images, forms, basic tables, and object support. It is designed for Web clients that do not support the full set of XHTML features; for example, Web clients such as mobile phones, PDAs, pagers, and settop boxes. The document type is rich enough for content authoring. XHTML Mobile Profile is designed as a common base that may be extended by additional modules from XHTML Modularization such as the Scripting Module. Thus it provides a common language supported by various kinds of user agents such as browsers. It is useful if the page format can be read and presented by many different versions of “legacy” browsers to maximize the user base among existing mobile telephone users for example.

The query server is typically connected to a database that stores detailed device profile information on mobile devices and desktop devices, including information on the device screen size, device capabilities and in particular the capabilities of the browser or microbrowser running on that device. The query server may be configured to detect the user agent identified in the HTTP headers contained in the request received from the mobile device's web browser. The server then adapts the package according to the model of mobile device.

The query server, and servers for indexing, calculating metrics and for crawling or metacrawling can be implemented using standard hardware. The hardware components of any server typically include: a central processing unit (CPU), an Input/Output (I/O) Controller, a system power and clock source; display driver; RAM; ROM; and a hard disk drive. A network interface provides connection to a computer network such as Ethernet, TCP/IP or other popular protocol network interfaces. The functionality may be embodied in software residing in computer-readable media (such as the hard drive, RAM, or ROM). A typical software hierarchy for the system can include a BIOS (Basic Input Output System) which is a set of low level computer hardware instructions, usually stored in ROM, for communications between an operating system, device driver(s) and hardware. Device drivers are hardware specific code used to communicate between the operating system and hardware peripherals. Applications are software applications written typically in C/C++, Java, assembler or equivalent which implement the desired functionality, running on top of and thus dependent on the operating system for interaction with other software code and hardware. The operating system loads after BIOS initializes, and controls and runs the hardware. Examples of operating systems include Linux™, Solaris™, Unix™, OSX™ Windows XP™ and equivalents.

Any of the additional features can be combined together and combined with any of the aspects. Other advantages will be apparent to those skilled in the art, especially over other prior art. No doubt many other effective alternatives will occur to the skilled person. It will be understood that the invention is not limited to the described embodiments and encompasses modifications apparent to those skilled in the art lying within the spirit and scope of the claims appended hereto.

1. A query server to provide a search service for searching computer accessible content, the query server being arranged to
receive a search query from a user on a mobile device,
output said search query to multiple sources of indexable information,
input an individual list of results from each of said multiple sources together with a scoring for each result wherein each result has a position in its associated individual list determined by its scoring,
combine said lists of results to form a single combined list wherein results in said single combined list are ranked using a combination of their scoring and position in their respective individual list and
send said combined list of search results to a user's mobile device.

2. A query server as claimed in claim 1, wherein the query server is arranged to
combine the results from selected individual lists to form at least one interim combined list and to
combine the results from the non-selected individual lists with the results in the at least one interim combined list.

3. A query server as claimed in claim 1, wherein the query server is arranged to
generate generic scores for all individual lists by normalising the scoring for each individual list, and
combine said lists using said generic scores.

4. A query server as claimed in claim 3, wherein the query server is arranged to combine the lists by using a function f(g,r) where g is the generic score and r is the rank in each individual list and where f(g_{N}, N)>f(g_{M}, M) for any N<M where g_{N} is the generic score of the Nth highest-scoring document of type X and g_{M} is the generic score of the Mth highest-scoring document of the same type X.

5. A query server as claimed in claim 3, wherein the query server is arranged to combine the lists by using a function
$$f ( g , r ) = ag + \frac{( 1 - a )}{r}$$
where g is the generic score, r is the rank in each individual list and a is a tuning factor having a value between 0 and 1.

6. A query server according to claim 5, wherein the query server is arranged to apply a different tuning factor for each combination step.

7. A query server according to claim 5, wherein the query server is arranged to adjust the tuning factor in real-time.

8. A query server according to claim 5, wherein the query server is arranged to prompt a user to adjust the tuning factor.

9. A method of providing a search service for searching computer accessible content, the method comprising
receiving a search query from a user on a mobile device,
outputting said search query to multiple sources of indexable information,
inputting an individual list of results from each of said multiple sources together with a scoring for each result wherein each result has a position in its associated individual list determined by its scoring,
combining said lists of results to form a single combined list wherein results in said single combined list are ranked using a combination of their scoring and position in their respective individual list and
sending said combined list of search results to a user's mobile device.

10. A method according to claim 9, comprising
first combining the results from selected individual lists to form at least one interim combined list and
second combining the results from the non-selected individual lists with the results in the at least one interim combined list to form said single combined list.

11. A method as claimed in claim 9, comprising
generating generic scores for all individual lists by normalising the scoring for each individual list, and
combining said lists using said generic scores.

12. A method as claimed in claim 11, comprising combining the lists by using a function f(g,r) where g is the generic score and r is the rank in each individual list and where
f(g_{N}, N)>f(g_{M}, M) for any N<M
where g_{N} is the generic score of the Nth highest-scoring document of type X and
g_{M} is the generic score of the Mth highest-scoring document of the same type X.

13. A method as claimed in claim 11, wherein comprising combining using a function
$$f ( g , r ) = ag + \frac{( 1 - a )}{r}$$
where g is the generic score, r is the rank in each individual list and a is a tuning factor having a value between 0 and 1.

14. A method as claimed in claim 13, comprising first combining the results from selected individual lists to form at least one interim combined list,
second combining the results from the non-selected individual lists with the results in the at least one interim combined list to form said single combined list, and applying a different tuning factor for the first and second combining steps.

15. A method as claimed in claim 13, comprising adjusting the tuning factor in real-time.

16. A method as claimed in claim 13, comprising prompting a user to adjust the tuning factor.

17. A program on a computer readable medium arranged to carry out the method claim 9.
